(19) United States
(12) Patent Application Publication
(10) Pub. No.: US 2025/0224908 A1
(43) Pub. Date: Jul. 10, 2025

(54) METHOD AND DEVICE FOR DISPLAYING NFT ARTWORK

(71) Applicant: CHUNG-HAO HSU, Taipei City (TW)

(72) Inventor: CHUNG-HAO HSU, Taipei City (TW)

(21) Appl. No.: 18/819,723

(22) Filed: Aug. 29, 2024

(30) Foreign Application Priority Data
Jan. 4, 2024 (TW) 113100336

(51) Int. Cl. G06F 3/14; G06K 19/06

(52) U.S. Cl. CPC G06F 3/1423; G06K 19/06018; G06K 19/06037; G06K 19/06112

(57) ABSTRACT

A method for displaying an NFT artwork, comprising: connecting to a user's electronic wallet; displaying the NFT artwork in the user's electronic wallet on a device; wherein the device displays an identification code corresponding to the NFT artwork. Through the method of displaying the NFT artwork, the user can display the NFT artworks in the user's electronic wallet on the device, thereby achieving the purpose of displaying the NFT artworks for viewers to appreciate and enhancing the feeling of actual connection to the NFT artwork. The viewers can also obtain relevant information corresponding to the NFT artwork through the identification code.

### BACKGROUND OF THE INVENTION

### Technical Field

The present invention relates generally to blockchain technology; and more particularly to a method for displaying an NFT artwork and a device for displaying an NFT artwork.

### Description of Related Art

It is known that blockchain has the characteristics of decentralization, non-tampering, full traceability, collective maintenance, and openness and transparency. With the technological evolution of blockchain, the virtual currency technology developed from blockchain has gradually received public attention. Virtual currencies mainly include Fungible Tokens (FT) and Non-Fungible Tokens (NFT). Fungible Tokens are tokens that can be replaced by each other and can be divided, such as Ethereum, Bitcoin, etc. Non-Fungible Tokens are indivisible and irreplaceable digital currencies. Currently, Non-Fungible Tokens are mainly used to connect to artistic objects such as digital creations.

However, the difference between NFT artworks and traditional artworks is that users cannot specifically display the owned NFT artworks. Therefore, how to provide a method and a device for displaying an NFT artwork, is an urgent problem to be solved.

### BRIEF SUMMARY OF THE INVENTION

In view of the above, the primary objective of the present invention is to provide a method and a device for displaying an NFT artwork, which allow users to display the NFT artwork the users own.

The present invention provides a method for displaying an NFT artwork, which comprising: connecting to a user's electronic wallet; displaying an NFT artwork in the user's electronic wallet on a device; wherein the device displays an identification code corresponding to the NFT artwork.

In an embodiment, the identification code is a one-dimensional barcode, a two-dimensional barcode, or other mobile barcodes, and an owner information of the NFT artwork is embedded in the identification code.

In an embodiment, a smart contract address of the NFT artwork is embedded in the identification code.

In an embodiment, the device is an electronic picture frame.

In an embodiment, the NFT artwork includes a plurality of NFT artworks, and the plurality of NFT artworks are displayed on the device in turn at regular time intervals.

In an embodiment, the NFT artwork includes a plurality of NFT artworks, and the device includes a plurality of devices; one of the plurality of NFT artworks is displayed on one of the plurality of devices, each device displays a different NFT artwork, and each device displays the identification code corresponding to the NFT artwork displayed on the device.

In an embodiment, the NFT artwork is a picture, an image, or an audio-visual work.

In an embodiment, further comprising a step of binding the device to the user's electronic wallet.

In an embodiment, further comprising a step of verifying the owner of the user's electronic wallet.

The present invention further provides a device for displaying an NFT artwork, wherein the device is an electronic picture frame and displays the NFT artwork according to the method for displaying the NFT artwork as claimed in claim 1; the device comprises a frame and a display, wherein the display is disposed on the frame and is used to display the NFT artwork and the identification code.

The effect of the present invention is that through the method for displaying the NFT artwork, the user could display the NFT artworks in the user's electronic wallet on the device for displaying the NFT artwork. In this way, the purpose of displaying the NFT artworks to viewers to enjoy can be achieved, which can enhance the feeling of actual connection between people and the NFT artworks. In addition, the viewers can also obtain relevant information corresponding the NFT artwork through the identification code.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a flowchart of the method for displaying the NFT artwork according to an embodiment of the present invention;

FIG. 2 is a schematic view of the device for displaying the NFT artwork according to an embodiment of the present invention;

FIG. 3 is a schematic view of the device for displaying the NFT artwork according to the embodiment of the present invention;

FIG. 4 is a schematic view of the device for displaying the NFT artwork according to another embodiment of the present invention.

FIG. 5 is a schematic view of the device for displaying the NFT artwork according to still another embodiment of the present invention.

### DETAILED DESCRIPTION OF THE INVENTION

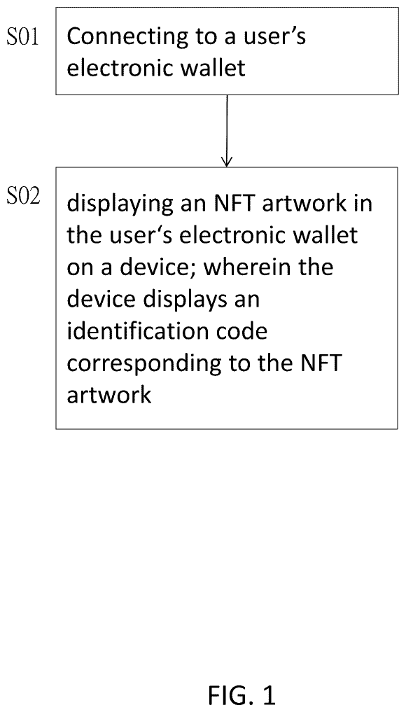

Please refer to FIG. 1, which is a flow chart of a method for displaying an NFT artwork according to an embodiment of the present invention.

The method for displaying the NFT artwork includes the following steps:

Step S01: connecting to a user's electronic wallet; for example, a user can log in to the user's electronic wallet through an application to connect to the user's electronic wallet, and then the user can read NFT artworks in the user's electronic wallet through the application.

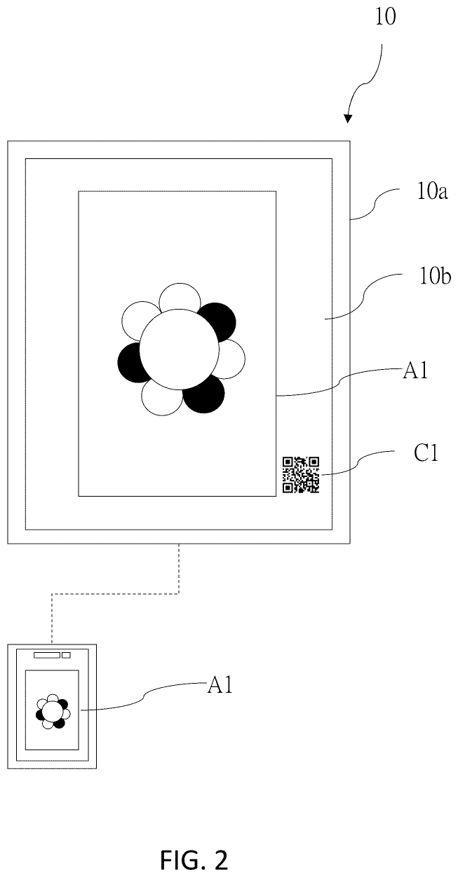

Step S02: displaying an NFT artwork A1 in the user's electronic wallet on a device 10, wherein the device 10 displays the NFT artwork A1 and an identification code C1 corresponding to the NFT artwork A1; for example, as shown in FIG. 2, the user can connect to the device 10 through the application on a mobile device. The application can display all NFT artworks A1 in the user's electronic wallet, and the user can choose the one of the NFT artworks to be displayed, thereby displaying the NFT artwork A1 selected by the user on the device 10.

Step S01 further includes the step of binding the device to the user's electronic wallet, and verifying an owner of the user's electronic wallet during the aforementioned binding process to confirm that the user using the device is the owner of the user's electronic wallet.

The identification code C1 can be a one-dimensional barcode, a two-dimensional barcode, or other mobile barcodes, and an owner information of the NFT artwork A1 is embedded in the identification code C1, whereby a viewer can operate, for example, a mobile device to scan the identification code C1 for viewing and confirming the owner of the NFT artwork A1.

In this embodiment, a smart contract address of the NFT artwork A1 is also embedded in the identification code C1. In this way, the viewer can operate, for example, a mobile device to scan the identification code C1 to directly conduct transactions for the NFT artwork A1 and purchase the NFT artwork A1 corresponding to the identification code C1.

Furthermore, in step S02, when the number of the NFT artworks in the user's electronic wallet is plural, the user can select one of the NFT artworks or more than one of the NFT artworks to be displayed. As shown in FIG. 2, when the user selects one of the NFT artworks to be displayed (i.e., the NFT artwork A1), the device 10 can display the NFT artwork A1 selected by the user and the corresponding identification code C1.

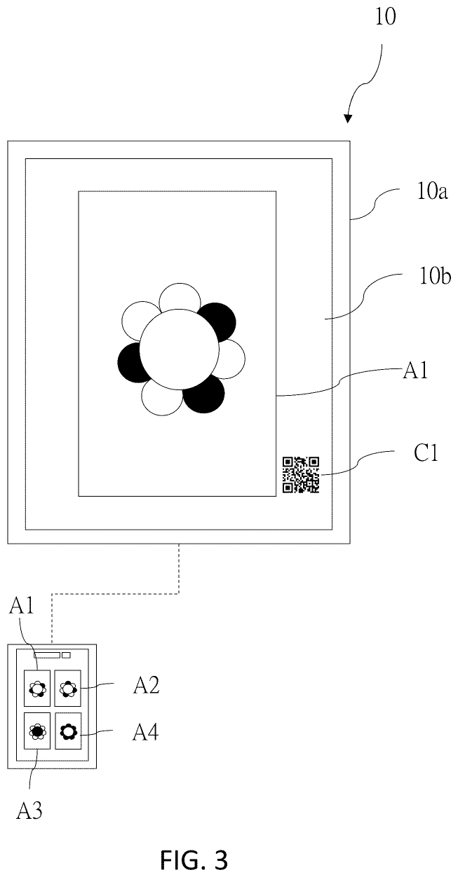

As shown in FIG. 3, when the user selects a plurality of NFT artworks A1, A2, A3, and A4 to be displayed, the device 10 can display the plurality of NFT artworks A1, A2, A3, and A4 in turn at regular time intervals. The regular time intervals may be, for example, one minute. In this way, the device 10 can alternately display the plurality of NFT artworks A1, A2, A3, and A4 selected by the user every one minute, and when the device 10 displays one of the plurality of NFT artworks A1, A2, A3, and A4 selected by the user, the device 10 also displays the corresponding identification code C1 for the viewer to scan.

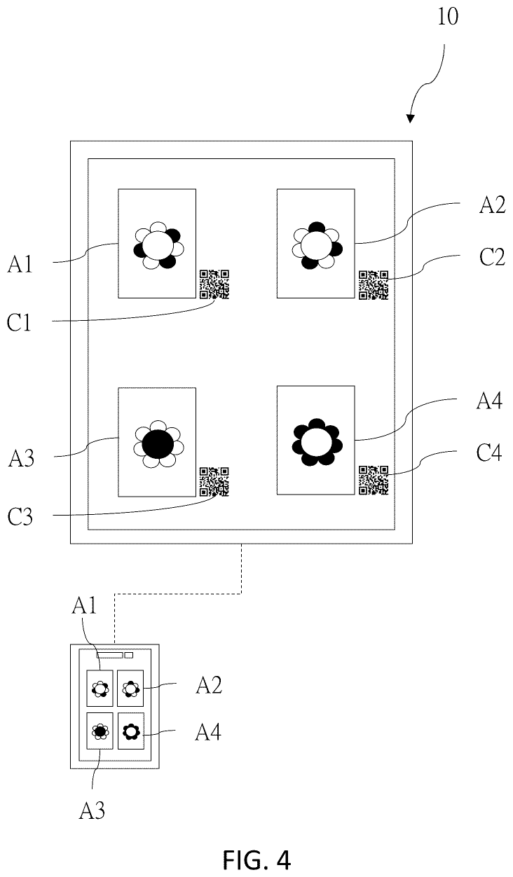

In addition, in other embodiments as shown in FIG. 4, when the user selects a plurality of NFT artworks A1, A2, A3, and A4 to be displayed, the device 10 can simultaneously display the plurality of NFT artworks A1, A2, A3, and A4 to be displayed and identification codes C1, C2, C3, and C4. The identification codes C1, C2, C3, and C4 correspond to the selected NFT artworks A1, A2, A3, and A4 respectively.

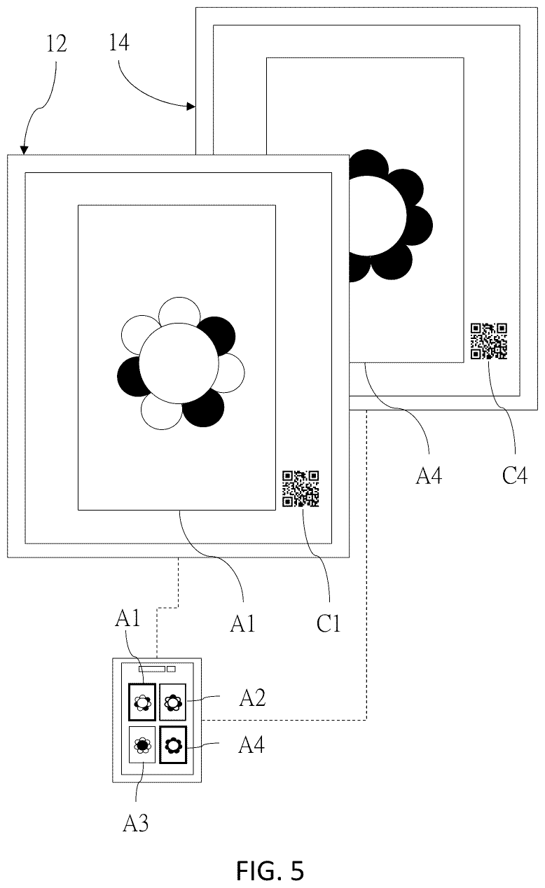

In this embodiment, one device 10 is used as an example. In other embodiments, the number of the device 10 can be plural, and one of the NFT artworks is displayed on one of the devices 10, each device 10 displays different NFT artworks, and each device 10 displays an identification code corresponding to the NFT artwork displayed by the device 10; for example, as shown in FIG. 5, the number of the devices 10 is two, namely a first device 12 and a second device 14. The user can connect to the first device 12 and the second device 14 respectively through the application. The user can select the NFT artwork A1 to be displayed on the first device 12 and the NFT artwork A4 to be displayed on the second device 14 through the application. Thereby, the NFT artwork A1 selected by the user and the identification code C1 are displayed on the first device 12 and the NFT artwork A4 and the identification code C4 are displayed on the second device 14. In this way, the devices 10 can also be placed in display spaces such as galleries to display the NFT artworks owned by the user.

In this embodiment, the NFT artwork A1 is illustrated by taking a picture as an example. In other embodiments, the NFT artwork A1 can also be an image or an audio-visual work.

Furthermore, in this embodiment, the device 10 is a device that can display an NFT artwork. The device 10 is, for example, an electronic picture frame, and can display the NFT artwork according to the aforementioned method for displaying the NFT artwork. As shown in FIG. 2, the device 10 includes a frame 10a and a display 10b. The display 10b is disposed on the frame 10a and is used to display the NFT artwork A1 and the identification code C1.

In summary, through the method and the device for displaying the NFT artwork, the user can display the NFT artwork in the user's electronic wallet on the device, thereby displaying the NFT artwork for the viewers to appreciate. The purpose of enhancing the feeling of actual connection between people and the NFT artwork could be achieved. In addition, the viewers can also obtain the relevant information corresponding to the NFT artwork through the identification code, thereby confirming the ownership of the NFT artwork and the purchasing information.

It must be pointed out that the embodiments described above are only some preferred embodiments of the present invention. All equivalent structures and methods which employ the concepts disclosed in this specification and the appended claims should fall within the scope of the present invention.

What is claimed is:

1. A method for displaying an NFT artwork, comprising:
connecting to a user's electronic wallet;
displaying an NFT artwork in the user's electronic wallet on a device;
wherein the device displays an identification code corresponding to the NFT artwork.

2. The method as claimed in claim 1, wherein the identification code is a one-dimensional barcode, a two-dimensional barcode, or other mobile barcodes, and an owner information of the NFT artwork is embedded in the identification code.

3. The method as claimed in claim 1, wherein a smart contract address of the NFT artwork is embedded in the identification code.

4. The method as claimed in claim 1, wherein the device is an electronic picture frame.

5. The method as claimed in claim 1, wherein the NFT artwork includes a plurality of NFT artworks, and the plurality of NFT artworks are displayed on the device in turn at regular time intervals.

6. The method as claimed in claim 1, wherein the NFT artwork includes a plurality of NFT artworks, and the device includes a plurality of devices; one of the plurality of NFT artworks is displayed on one of the plurality of devices, each device displays a different NFT artwork, and each device displays the identification code corresponding to the NFT artwork displayed on the device.

7. The method as claimed in claim 1, wherein the NFT artwork is a picture, an image, or an audio-visual work.

8. The method as claimed in claim 1, further comprising a step of binding the device to the user's electronic wallet.

9. The method as claimed in claim 8, further comprising a step of verifying an owner of the user's electronic wallet.

10. A device for displaying an NFT artwork, wherein the device is an electronic picture frame and displays the NFT artwork according to the method for displaying the NFT artwork as claimed in claim 1; the device comprises a frame and a display, wherein the display is disposed on the frame and is used to display the NFT artwork and the identification code.
